(19) United States
(12) Patent Application Publication
(10) Pub. No.: US 2018/0139627 A1
(43) Pub. Date: May 17, 2018

(54) DIVIDED SIGNAL BOOSTER SYSTEM

(71) Applicant: WILSON ELECTRONICS, LLC, St. George, UT (US)

(72) Inventors: Christopher Ken Ashworth, St. George, UT (US); Patrick Lee Cook, Cedar City, UT (US)

(21) Appl. No.: 15/814,228

(22) Filed: Nov. 15, 2017

Related U.S. Application Data
(60) Provisional application No. 62/422,499, filed on Nov. 15, 2016.

(51) Int. Cl. H04W 16/26; H04B 7/026; H04B 7/145; H04B 7/155

(52) U.S. Cl. CPC H04W 16/26; H04B 7/026; H04B 7/15535; H04B 7/15507; H04B 7/145

(57) ABSTRACT

Technology for a cellular signal booster system is disclosed. The cellular signal booster system can include a first booster device and a second booster device. The first booster device can be operable to convert a cellular signal at a first frequency to a cellular signal at a second frequency. The second booster device can be operable to receive the cellular signal at the second frequency over an unlicensed band from the first booster device, and convert the cellular signal at the second frequency to a cellular signal at the first frequency for transmission in a wireless communication network.

### RELATED APPLICATIONS

The present application claims priority to U.S. Provisional Patent Application No. 62/422,499, filed Nov. 15, 2016 with a docket number of 3969-107.PROV.US, the entire specification of which is hereby incorporated by reference in its entirety for all purposes.

### BACKGROUND

Signal boosters and repeaters can be used to increase the quality of wireless communication between a wireless device and a wireless communication access point, such as a cell tower. Signal boosters can improve the quality of the wireless communication by amplifying, filtering, and/or applying other processing techniques to uplink and downlink signals communicated between the wireless device and the wireless communication access point.

As an example, the signal booster can receive, via an antenna, downlink signals from the wireless communication access point. The signal booster can amplify the downlink signal and then provide an amplified downlink signal to the wireless device. In other words, the signal booster can act as a relay between the wireless device and the wireless communication access point. As a result, the wireless device can receive a stronger signal from the wireless communication access point. Similarly, uplink signals from the wireless device (e.g., telephone calls and other data) can be directed to the signal booster. The signal booster can amplify the uplink signals before communicating, via an antenna, the uplink signals to the wireless communication access point.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a signal booster in communication with a wireless device and a base station in accordance with an example;

FIG. 2 illustrates a cellular signal booster configured to amplify uplink (UL) and downlink (DL) signals using one or more downlink signal paths and one or more uplink signal paths in accordance with an example;

FIG. 3 illustrates a wireless communication system in accordance with an example;

FIG. 4 illustrates a divided signal booster system in accordance with an example;

FIG. 5 illustrates a wireless communication system in accordance with an example;

FIG. 6 illustrates a cellular signal booster system in accordance with an example;

FIG. 7 illustrates another cellular signal booster system in accordance with an example;

FIG. 8 illustrates yet another cellular signal booster system in accordance with an example; and

FIG. 9 illustrates a wireless device in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

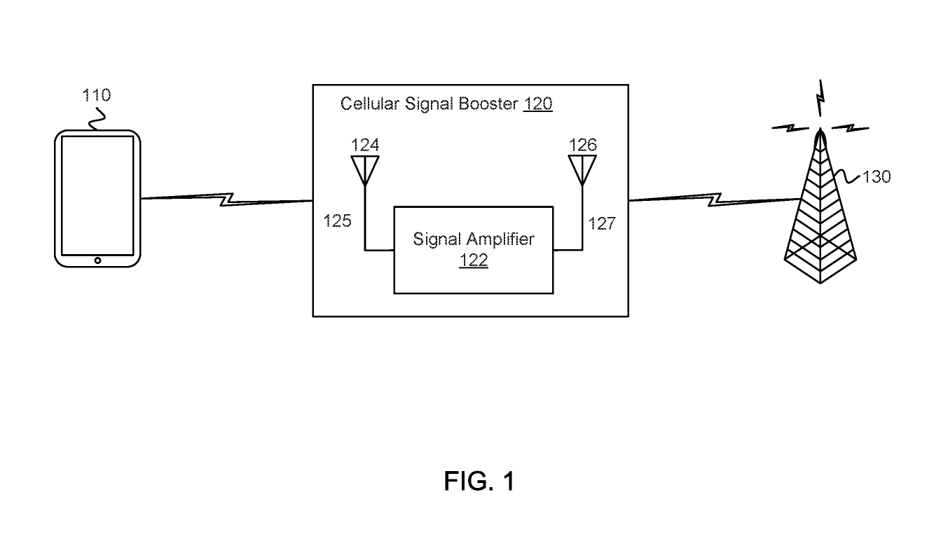

FIG. 1 illustrates an exemplary signal booster 120 in communication with a wireless device 110 and a base station 130. The signal booster 120 can be referred to as a repeater. A repeater can be an electronic device used to amplify (or boost) signals. The signal booster 120 (also referred to as a cellular signal amplifier) can improve the quality of wireless communication by amplifying, filtering, and/or applying other processing techniques via a signal amplifier 122 to uplink signals communicated from the wireless device 110 to the base station 130 and/or downlink signals communicated from the base station 130 to the wireless device 110. In other words, the signal booster 120 can amplify or boost uplink signals and/or downlink signals bi-directionally. In one example, the signal booster 120 can be at a fixed location, such as in a home or office. Alternatively, the signal booster 120 can be attached to a mobile object, such as a vehicle or a wireless device 110.

In one configuration, the signal booster 120 can include an integrated device antenna 124 (e.g., an inside antenna or a coupling antenna) and an integrated node antenna 126 (e.g., an outside antenna). The integrated node antenna 126 can receive the downlink signal from the base station 130. The downlink signal can be provided to the signal amplifier 122 via a second coaxial cable 127 or other type of radio frequency connection operable to communicate radio frequency signals. The signal amplifier 122 can include one or more cellular signal amplifiers for amplification and filtering. The downlink signal that has been amplified and filtered can be provided to the integrated device antenna 124 via a first coaxial cable 125 or other type of radio frequency connection operable to communicate radio frequency signals. The integrated device antenna 124 can wirelessly communicate the downlink signal that has been amplified and filtered to the wireless device 110.

Similarly, the integrated device antenna 124 can receive an uplink signal from the wireless device 110. The uplink signal can be provided to the signal amplifier 122 via the first coaxial cable 125 or other type of radio frequency connection operable to communicate radio frequency signals. The signal amplifier 122 can include one or more cellular signal amplifiers for amplification and filtering. The uplink signal that has been amplified and filtered can be provided to the integrated node antenna 126 via the second coaxial cable 127 or other type of radio frequency connection operable to communicate radio frequency signals. The integrated node antenna 126 can communicate the uplink signal that has been amplified and filtered to the base station 130.

In one example, the signal booster 120 can filter the uplink and downlink signals using any suitable analog or digital filtering technology including, but not limited to, surface acoustic wave (SAW) filters, bulk acoustic wave (BAW) filters, film bulk acoustic resonator (FBAR) filters, ceramic filters, waveguide filters or low-temperature co-fired ceramic (LTCC) filters.

In one example, the signal booster 120 can send uplink signals to a node and/or receive downlink signals from the node. The node can comprise a wireless wide area network (WWAN) access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or another type of WWAN access point.

In one configuration, the signal booster 120 used to amplify the uplink and/or a downlink signal is a handheld booster. The handheld booster can be implemented in a sleeve of the wireless device 110. The wireless device sleeve can be attached to the wireless device 110, but can be removed as needed. In this configuration, the signal booster 120 can automatically power down or cease amplification when the wireless device 110 approaches a particular base station. In other words, the signal booster 120 can determine to stop performing signal amplification when the quality of uplink and/or downlink signals is above a defined threshold based on a location of the wireless device 110 in relation to the base station 130.

In one example, the signal booster 120 can include a battery to provide power to various components, such as the signal amplifier 122, the integrated device antenna 124 and the integrated node antenna 126. The battery can also power the wireless device 110 (e.g., phone or tablet). Alternatively, the signal booster 120 can receive power from the wireless device 110.

In one configuration, the signal booster 120 can be a Federal Communications Commission (FCC)-compatible consumer signal booster. As a non-limiting example, the signal booster 120 can be compatible with FCC Part 20 or 47 Code of Federal Regulations (C.F.R.) Part 20.21 (Mar. 21, 2013). In addition, the signal booster 120 can operate on the frequencies used for the provision of subscriber-based services under parts 22 (Cellular), 24 (Broadband PCS), 27 (AWS-1, 700 MHz Lower A-E Blocks, and 700 MHz Upper C Block), and 90 (Specialized Mobile Radio) of 47 C.F.R. The signal booster 120 can be configured to automatically self-monitor its operation to ensure compliance with applicable noise and gain limits. The signal booster 120 can either self-correct or shut down automatically if the signal booster's operations violate the regulations defined in FCC Part 20.21.

In one configuration, the signal booster 120 can improve the wireless connection between the wireless device 110 and the base station 130 (e.g., cell tower) or another type of wireless wide area network (WWAN) access point (AP). The signal booster 120 can boost signals for cellular standards, such as the Third Generation Partnership Project (3GPP) Long Term Evolution (LTE) Release 8, 9, 10, 11, 12, or 13 standards or Institute of Electronics and Electrical Engineers (IEEE) 802.16. In one configuration, the signal booster 120 can boost signals for 3GPP LTE Release 13.0.0 (March 2016) or other desired releases. The signal booster 120 can boost signals from the 3GPP Technical Specification 36.101 (Release 12 Jun. 2015) bands or LTE frequency bands. For example, the signal booster 120 can boost signals from the LTE frequency bands: 2, 4, 5, 12, 13, 17, and 25. In addition, the signal booster 120 can boost selected frequency bands based on the country or region in which the signal booster is used, including any of bands 1-70 or other bands, as disclosed in ETSI TS136 104 V13.5.0 (2016-10).

The number of LTE frequency bands and the level of signal improvement can vary based on a particular wireless device, cellular node, or location. Additional domestic and international frequencies can also be included to offer increased functionality. Selected models of the signal booster 120 can be configured to operate with selected frequency bands based on the location of use. In another example, the signal booster 120 can automatically sense from the wireless device 110 or base station 130 (or GPS, etc.) which frequencies are used, which can be a benefit for international travelers.

In one example, the integrated device antenna 124 and the integrated node antenna 126 can be comprised of a single antenna, an antenna array, or have a telescoping form-factor. In another example, the integrated device antenna 124 and the integrated node antenna 126 can be a microchip antenna. An example of a microchip antenna is AMMAL001. In yet another example, the integrated device antenna 124 and the integrated node antenna 126 can be a printed circuit board (PCB) antenna. An example of a PCB antenna is TE 2118310-1.

In one example, the integrated device antenna 124 can receive uplink (UL) signals from the wireless device 100 and transmit DL signals to the wireless device 100 using a single antenna. Alternatively, the integrated device antenna 124 can receive UL signals from the wireless device 100 using a dedicated UL antenna, and the integrated device antenna 124 can transmit DL signals to the wireless device 100 using a dedicated DL antenna.

In one example, the integrated device antenna 124 can communicate with the wireless device 110 using near field communication. Alternatively, the integrated device antenna 124 can communicate with the wireless device 110 using far field communication.

In one example, the integrated node antenna 126 can receive downlink (DL) signals from the base station 130 and transmit uplink (UL) signals to the base station 130 via a single antenna. Alternatively, the integrated node antenna 126 can receive DL signals from the base station 130 using a dedicated DL antenna, and the integrated node antenna 126 can transmit UL signals to the base station 130 using a dedicated UL antenna.

In one configuration, multiple signal boosters can be used to amplify UL and DL signals. For example, a first signal booster can be used to amplify UL signals and a second signal booster can be used to amplify DL signals. In addition, different signal boosters can be used to amplify different frequency ranges.

In one configuration, the signal booster 120 can be configured to identify when the wireless device 110 receives a relatively strong downlink signal. An example of a strong downlink signal can be a downlink signal with a signal strength greater than approximately −80 dBm. The signal booster 120 can be configured to automatically turn off selected features, such as amplification, to conserve battery life. When the signal booster 120 senses that the wireless device 110 is receiving a relatively weak downlink signal, the integrated booster can be configured to provide amplification of the downlink signal. An example of a weak downlink signal can be a downlink signal with a signal strength less than −80 dBm.

In one example, the signal booster 120 can also include one or more of: a waterproof casing, a shock absorbent casing, a flip-cover, a wallet, or extra memory storage for the wireless device. In one example, extra memory storage can be achieved with a direct connection between the signal booster 120 and the wireless device 110. In another example, Near-Field Communications (NFC), Bluetooth v4.0, Bluetooth Low Energy, Bluetooth v4.1, Bluetooth v4.2, Bluetooth 5, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, or IEEE 802.11ad can be used to couple the signal booster 120 with the wireless device 110 to enable data from the wireless device 110 to be communicated to and stored in the extra memory storage that is integrated in the signal booster 120. Alternatively, a connector can be used to connect the wireless device 110 to the extra memory storage.

In one example, the signal booster 120 can include photovoltaic cells or solar panels as a technique of charging the integrated battery and/or a battery of the wireless device 110. In another example, the signal booster 120 can be configured to communicate directly with other wireless devices with signal boosters. In one example, the integrated node antenna 126 can communicate over Very High Frequency (VHF) communications directly with integrated node antennas of other signal boosters. The signal booster 120 can be configured to communicate with the wireless device 110 through a direct connection, Near-Field Communications (NFC), Bluetooth v4.0, Bluetooth Low Energy, Bluetooth v4.1, Bluetooth v4.2, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, a TV White Space Band (TVWS), or any other industrial, scientific and medical (ISM) radio band. Examples of such ISM bands include 2.4 GHz, 3.6 GHz, 4.9 GHz, 5 GHz, or 5.9 GHz. This configuration can allow data to pass at high rates between multiple wireless devices with signal boosters. This configuration can also allow users to send text messages, initiate phone calls, and engage in video communications between wireless devices with signal boosters. In one example, the integrated node antenna 126 can be configured to couple to the wireless device 110. In other words, communications between the integrated node antenna 126 and the wireless device 110 can bypass the integrated booster.

In another example, a separate VHF node antenna can be configured to communicate over VHF communications directly with separate VHF node antennas of other signal boosters. This configuration can allow the integrated node antenna 126 to be used for simultaneous cellular communications. The separate VHF node antenna can be configured to communicate with the wireless device 110 through a direct connection, Near-Field Communications (NFC), Bluetooth v4.0, Bluetooth Low Energy, Bluetooth v4.1, Bluetooth v4.2, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, a TV White Space Band (TVWS), or any other industrial, scientific and medical (ISM) radio band.

In one configuration, the signal booster 120 can be configured for satellite communication. In one example, the integrated node antenna 126 can be configured to act as a satellite communication antenna. In another example, a separate node antenna can be used for satellite communications. The signal booster 120 can extend the range of coverage of the wireless device 110 configured for satellite communication. The integrated node antenna 126 can receive downlink signals from satellite communications for the wireless device 110. The signal booster 120 can filter and amplify the downlink signals from the satellite communication. In another example, during satellite communications, the wireless device 110 can be configured to couple to the signal booster 120 via a direct connection or an ISM radio band. Examples of such ISM bands include 2.4 GHz, 3.6 GHz, 4.9 GHz, 5 GHz, or 5.9 GHz.

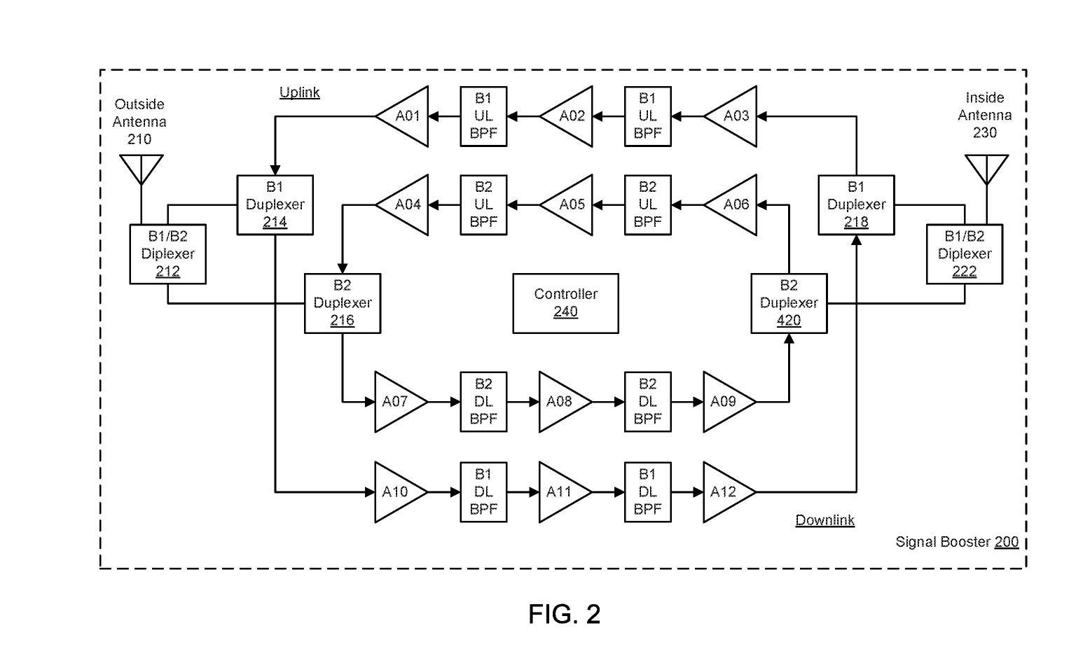

FIG. 2 illustrates an exemplary bi-directional wireless signal booster 200 configured to amplify uplink (UL) and downlink (DL) signals using a separate signal path for each UL frequency band and DL frequency band and a controller 240. The bi-directional wireless signal booster 200 can be integrated with a GPS module in a signal booster. An outside antenna 210, or an integrated node antenna, can receive a downlink signal. For example, the downlink signal can be received from a base station (not shown). The downlink signal can be provided to a first B1/B2 diplexer 212, wherein B1 represents a first frequency band and B2 represents a second frequency band. The first B1/B2 diplexer 212 can create a B1 downlink signal path and a B2 downlink signal path. Therefore, a downlink signal that is associated with B1 can travel along the B1 downlink signal path to a first B1 duplexer 214, or a downlink signal that is associated with B2 can travel along the B2 downlink signal path to a first B2 duplexer 216. After passing the first B1 duplexer 214, the downlink signal can travel through a series of amplifiers (e.g., A10, A11 and A12) and downlink band pass filters (BPF) to a second B1 duplexer 218. Alternatively, after passing the first B2 duplexer 216, the downlink can travel through a series of amplifiers (e.g., A07, A08 and A09) and downlink band pass filters (BFF) to a second B2 duplexer 220. At this point, the downlink signal (B1 or B2) has been amplified and filtered in accordance with the type of amplifiers and BPFs included in the bi-directional wireless signal booster 200. The downlink signals from the second B1 duplexer 218 or the second B2 duplexer 220, respectively, can be provided to a second B1/B2 diplexer 222. The second B1/B2 diplexer 222 can provide an amplified downlink signal to an inside antenna 230, or an integrated device antenna. The inside antenna 230 can communicate the amplified downlink signal to a wireless device (not shown), such as a mobile phone.

In one example, the inside antenna 230 can receive an uplink (UL) signal from the wireless device. The uplink signal can be provided to the second B1/B2 diplexer 222. The second B1/B2 diplexer 222 can create a B1 uplink signal path and a B2 uplink signal path. Therefore, an uplink signal that is associated with B1 can travel along the B1 uplink signal path to the second B1 duplexer 218, or an uplink signal that is associated with B2 can travel along the B2 uplink signal path to the second B2 duplexer 222. After passing the second B1 duplexer 218, the uplink signal can travel through a series of amplifiers (e.g., A01, A02 and A03) and uplink band pass filters (BPF) to the first B1 duplexer 214. Alternatively, after passing the second B2 duplexer 220, the uplink signal can travel through a series of amplifiers (e.g., A04, A05 and A06) and uplink band pass filters (BPF) to the first B2 duplexer 216. At this point, the uplink signal (B1 or B2) has been amplified and filtered in accordance with the type of amplifiers and BFFs included in the bi-directional wireless signal booster 200. The uplink signals from the first B1 duplexer 214 or the first B2 duplexer 216, respectively, can be provided to the first B1/B2 diplexer 12. The first B1/B2 diplexer 212 can provide an amplified uplink signal to the outside antenna 210. The outside antenna can communicate the amplified uplink signal to the base station.

In one example, the bi-directional wireless signal booster 200 can be a 6-band booster. In other words, the bi-directional wireless signal booster 200 can perform amplification and filtering for downlink and uplink signals having a frequency in bands B1, B2, B3 B4, B5 and/or B6.

In one example, the bi-directional wireless signal booster 200 can use the duplexers to separate the uplink and downlink frequency bands, which are then amplified and filtered separately. A multiple-band cellular signal booster can typically have dedicated radio frequency (RF) amplifiers (gain blocks), RF detectors, variable RF attenuators and RF filters for each uplink and downlink band.

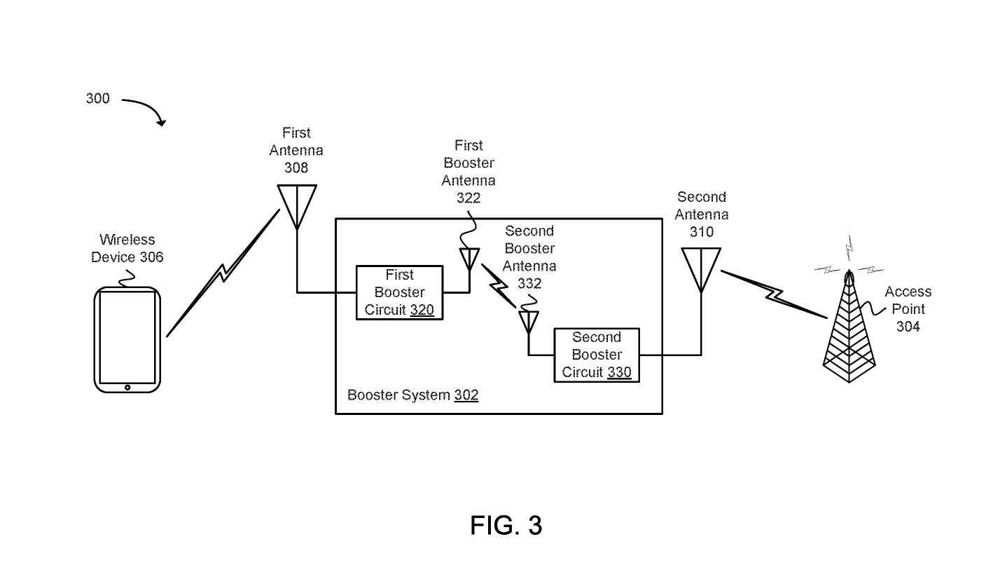

FIG. 3 illustrates an example wireless communication system 300 (referred to hereinafter as “system 300”). The system 300 can be configured to provide wireless communication services to wireless devices, such as a wireless device 306 via an access point 304. The system 300 can further include a bidirectional signal booster system 302 (referred to hereinafter as “the booster system 302”). The booster system 302 can be any suitable system, device, or apparatus configured to receive wireless signals (e.g., radio frequency (RF) signals communicated in one or more frequency bands) communicated between the access point 304 and the wireless device 306. The booster system 302 can be configured to amplify, mute, repeat, filter, and/or otherwise process the received wireless signals and can be configured to re-transmit the processed wireless signals. Although not expressly illustrated in FIG. 3, the system 300 can include any number of access points 304 configured to provide wireless communication services to any number of wireless devices 306. In this example, the booster system 302 can communicate wireless signals from multiple access points 304 to multiple different wireless devices 306, from a single access point 304 to multiple different wireless devices 306, or from multiple access points 304 to one wireless device 306.

The wireless communication services provided by the system 300 can include voice services, data services, messaging services, and/or any suitable combination thereof. The system 300 can include a Frequency Division Duplexing (FDD) network, a Frequency Division Multiple Access (FDMA) network, an Orthogonal FDMA (OFDMA) network, a Code Division Multiple Access (CDMA) network, a Time Division Multiple Access (TDMA) network, a Direct Sequence Spread Spectrum (DSSS) network, a Frequency Hopping Spread Spectrum (FHSS) network, and/or some other wireless communication network. In one example, the system 300 can be configured to operate as a second generation (2G) wireless communication network, a third generation (3G) wireless communication network, a fourth generation (4G) wireless communication network, a Wi-Fi network, or some other communication network. Alternatively, the system 300 can be configured to operate as a Long Term Evolution (LTE) or LTE Advanced wireless communication network.

The access point 304 can be any suitable wireless network communication point and can include, by way of example but not limitation, a base station, a remote radio head (RRH), a satellite, a wireless router, or any other suitable communication point. The wireless device 306 can be any device that can use the system 300 to obtain wireless communication services and can include, by way of example and not limitation, mobile access terminals, such as a cellular phone, a smartphone, a personal data assistant (PDA), a laptop computer, a tablet computer, among others; non-mobile access terminals, such as a personal computer, a wireless router, a modem, among others; or any other similar device configured to communicate within the system 300.

As wireless signals propagate between the access point 304 and the wireless device 306, the wireless signals can be affected during the propagation such that, in some instances, the wireless signals can be substantially degraded. The signal degradation can result in the access point 304 or the wireless device 306 not receiving, detecting, or decoding information from the wireless signals. Therefore, the booster system 302 can be configured to increase the power of and/or improve the signal quality of the wireless signals such that the communication of the wireless signals between the access point 304 and the wireless device 306 can be improved.

In one example, the booster system 302 can receive a wireless signal communicated between the access point 304 and the wireless device 306 and can output a wireless signal that is amplified based on the received wireless signal. As an example, the booster system 302 can amplify the wireless signal by applying a gain to the wireless signal. The wireless signal can be amplified by converting the wireless signal to an electrical signal and applying the gain to the electrical signal. The gain can be a set gain or a variable gain, and can be less than, equal to, or greater than one. Therefore, in the present technology, the term “amplify” can refer to applying any gain to a wireless signal including gains that are less than one.

In one example, the booster system 302 can adjust the gain based on conditions associated with communicating the wireless signals (e.g., providing noise floor protection in the system 300, internal oscillation of the booster system 302, external oscillation (e.g., antenna to antenna oscillations) of the booster system 302, and/or overload protection at the access point 304). The booster system 302 can adjust the gain in accordance with the FCC Consumer Booster Standard. The booster system 302 can adjust the gain in real time. The booster system 302 can also filter out noise associated with the received wireless signal during demodulation, such that the retransmitted wireless signal can be a cleaner signal than the received wireless signal. Therefore, the booster system 302 can improve the communication of wireless signals between the access point 304 and the wireless device 306.

For example, the wireless device 306 can communicate a wireless uplink signal intended for reception by the access point 304 and a first antenna 308 can be configured to receive the wireless uplink signal. The first antenna 308 can be configured to convert the received wireless uplink signal into a first electrical uplink signal.

The first electrical uplink signal can be provided to a first booster device 320. In particular, the first antenna 308 can be communicatively coupled to a first interface port (not expressly depicted in FIG. 3) of the first booster device 320 such that the first booster device 320 can receive the first electrical uplink signal from the first antenna 308 at the first interface port. An interface port can be any suitable port configured to interface the first booster device 320 with another device (e.g., an antenna, a modem, another signal booster, etc.) through a wired connection from which the first booster device 320 can receive a signal and/or to which the first booster device 320 can communicate a signal.

The first booster device 320 can be configured to filter, amplify, and convert the first electrical uplink signal to an electrical first booster uplink signal. The first booster device 320 can provide the electrical first booster uplink signal by way of a second interface port of the first booster device 320 to a first booster antenna 322. The first booster antenna 322 can be configured to receive the electrical first-booster uplink signal and can convert the electrical first booster uplink signal to a wireless booster uplink signal that that can be transmitted by the first booster antenna 322.

In one example, the wireless booster uplink signal can be at a frequency that is different from the frequency of the wireless uplink signal. The wireless booster uplink signal can be at a frequency that is not used by the access point 304 or the wireless device 306 in the system 300 to provide wireless communication between the access point 304 and the wireless device 306 without the use of the booster system 302.

The wireless booster uplink signal can be received by a second booster antenna 332. The second booster antenna 332 can be configured to convert the received wireless booster uplink signal into an electrical second booster uplink signal. The second booster antenna 332 can provide the electrical second booster uplink signal to a second booster device 330. In particular, the second booster antenna 332 can provide the second electrical booster uplink signal to a first interface port of the second booster device 330.

The second booster device 330 can be configured to filter, amplify, and convert the electrical second booster uplink signal to a second electrical uplink signal. The second booster device 330 can provide the second electrical uplink signal to a second antenna 310 through a second interface port of the second booster device 330. The second antenna 310 can be configured to receive the second electrical uplink signal from the second interface port and can convert the second electrical uplink signal into a wireless uplink signal that can also be transmitted by the second antenna 310. The wireless uplink signal can then be received by the access point 304.

In one example, the booster system 302 can also be configured to filter the received wireless uplink signal to remove at least some noise associated with the received wireless uplink signal. Consequently, the wireless uplink signal can have a better signal-to-noise ratio (SNR) than the wireless uplink signal that can be received by the first antenna 308. Accordingly, the booster system 302 can be configured to improve the communication of uplink signals between the access point 304 and the wireless device 306.

The use of the term “uplink signal,” without specifying wireless or electrical uplink signals, can refer to wireless uplink signals or electrical uplink signals. Additionally, the use of the term “uplink signal,” without specifying, can include signals transmitted to second booster device 330 from the first booster device 320 at a first frequency or signals transmitted between the wireless device 306 and the access point 304 at a second different frequency.

As another example, the access point 304 can communicate a wireless downlink signal intended for the wireless device 306 and the second antenna 310 can be configured to receive the wireless downlink signal. The second antenna 310 can convert the received wireless downlink signal into a first electrical downlink signal and provide the first electrical downlink signal to the second booster device 330 by way of the second interface port of the second booster device 330. The second booster device 330 can filter, amplify, and convert, the first electrical downlink signal to an electrical second booster downlink signal. The second booster device 330 can provide the electrical second booster downlink signal to the second booster antenna 332 by way of a first interface port of the second booster device 330.

The second booster antenna 332 can convert the electrical second booster downlink signal to a wireless booster downlink signal that can be transmitted by the second booster antenna 332 to the first booster antenna 322. The first booster antenna 322 can be configured to receive the wireless booster downlink signal and convert the wireless booster downlink signal to an electrical first booster downlink signal. The first booster antenna 322 can be configured to provide the electrical first booster downlink signal to the first booster device 320 by way of the second interface port of the first booster device 320.

The first booster device 320 can be configured to filter, amplify, and convert the electrical first booster downlink signal to a second electrical downlink signal. The first booster device 320 can be configured to provide the second electrical downlink signal to the first antenna 308 through the first interface port of the first booster device 320. The first antenna 308 can receive and convert the second electrical downlink signal into a wireless downlink signal that can also be transmitted by the first antenna 308. The wireless downlink signal can then be received by the wireless device 306.

In one example, the booster system 302 can also be configured to filter the received wireless downlink signal to remove at least some noise associated with the received wireless downlink signal. Therefore, the wireless downlink signal can have a better SNR than the wireless downlink signal received by the second antenna 310. Accordingly, the booster system 302 can also be configured to improve the communication of downlink signals, which can be second direction signals, between the access point 304 and the wireless device 306.

The use of the term “downlink signal,” without specifying wireless or electrical downlink signals, can refer to wireless downlink signals or electrical downlink signals. Additionally, the use of the term “downlink signal,” without specifying can include signals transmitted to first booster device 320 from the second booster device 330 at a first frequency or signals transmitted between the wireless device 306 and the access point 304 at a second different frequency.

In one example, a distance between the booster system 302 and the wireless device 306 can be relatively close as compared to a distance between the booster system 302 and the access point 304. Further, the distance between the first booster device 320 and the second booster device 330 can be relatively close as compared to the distance between the booster system 302 and the access point 304. For example, the booster system 302 can be installed in a building, and the first antenna 308 can be installed outside of the building and the second antenna 310 can be installed inside the building. In this example, the booster system 302 can operate to improve data communications between the wireless device 306 and the access point 304 while the wireless device 306 is in or near the building. Furthermore, the booster system 302, and in particular, the first booster device 320 and the second booster device 330 can be configured such that the first antenna 308 and the second antenna 310 can be wirelessly coupled instead of coupled with a wire, such as a coaxial cable, to avoid installation of a wire through the building.

Further, the system 300 can include any number of booster systems 302, access points 304, and/or wireless devices 306. Additionally, the booster system 302 can be coupled to multiple antennas, like the first antenna 308, which are configured to communicate with wireless devices. Additionally, the booster system 302 can be configured to communicate with the wireless device 306 via wired communications (e.g., using electrical signals communicated over a wire) instead of wireless communications (e.g., via wireless signals).

Additionally or alternately, although the booster system 302 is illustrated and described with respect to performing operations with respect to wireless communications such as receiving and transmitting wireless signals via the first antenna 308 and the second antenna 310, the scope of the present technology is not limited to such applications. For example, the booster system 302 (or other signal boosters described herein) can be configured to perform similar operations with respect to communications that are not necessarily wireless, such as processing signals that can be received and/or transmitted via one or more modems or other signal boosters communicatively coupled to the interface ports of the booster system 302 via a wired connection.

Additionally or alternately, the booster system 302 can be configured to perform operations on multiple different frequency communication bands. For example, the communication spectrum for wireless communications can include multiple bands that include uplink channels and downlink channels. In this example, the booster system 302 can operate to boost uplink and downlink signals throughout the channels of multiple frequency bands simultaneously. The frequencies of the wireless signals between the first and second booster devices 320 and 330 can be different and outside of the multiple bands used for communication between the access point 304 and the wireless device 306.

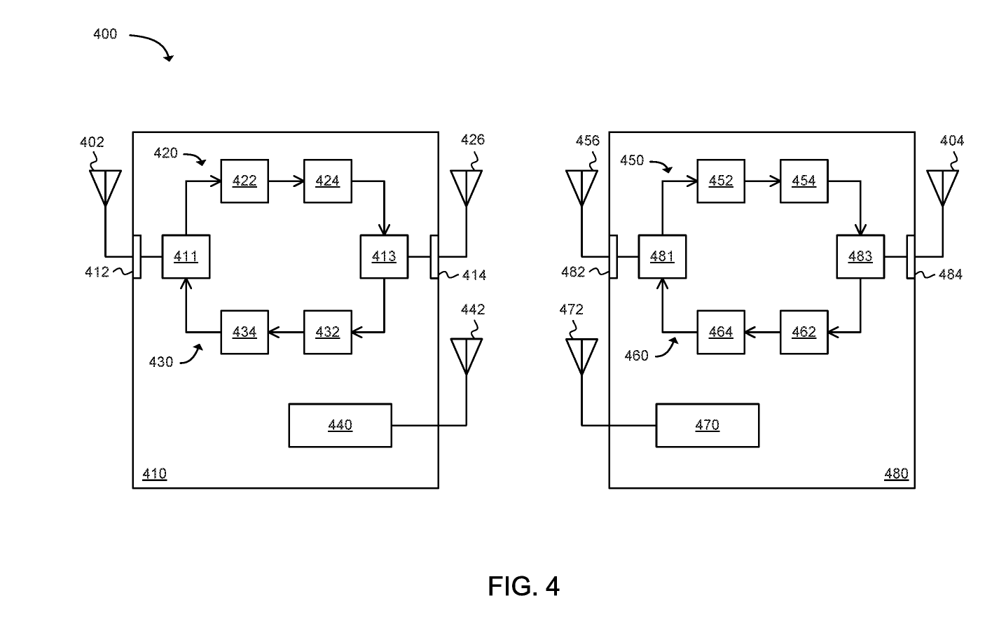

FIG. 4 illustrates an example divided signal booster system 400 (the system 400). In one example, the system 400 can be part of a wireless communication system, such as the system 300 illustrated in FIG. 3 and can operate in a similar manner as the booster system 302 of FIG. 3.

The system 400 can include a first booster device 410 and a second booster device 480. The first booster device 410 can operate in a manner analogous to the operation of the first booster device 320 of FIG. 3. The second booster device 480 can operate in a manner analogous to the operation of the second booster device 330 of FIG. 3.

The first booster device 410 can include a first uplink path 420 and a first downlink path 430 coupled between a first interface port 412 and a second interface port 414. The first booster device 410 can also include a first downlink path 430 coupled between the first interface port 412 and a second interface port 414.

The first interface port 412 can be coupled to a first cellular antenna 402. The first cellular antenna 402 can be configured to transmit downlink wireless signal to and receive uplink wireless signals from a wireless device, such as the wireless device 306 of FIG. 3. The frequencies of the uplink and downlink signals communicated between the first cellular antenna 402 and the wireless device can be frequencies associated with cellular communication networks. For example, the frequencies of the uplink and downlink signals can be located in bands that range between 700 and 2100 megahertz (MHz) frequency, among other frequencies. For example, the frequencies can be located in cellular frequency bands 2, 4, 5, 12, 13, 17, 25, and 26, among other cellular frequency bands.

The first uplink path 420 can be configured to receive uplink signals from the first cellular antenna 402 via the first interface port 412 and a first duplexer 411. The first uplink path 420 can include a first uplink mixer circuit 422 and a first uplink amplification circuit 424. The first uplink mixer circuit 422 can be configured to receive the uplink signal at an uplink cellular frequency and to convert the uplink signal to an uplink booster frequency. The uplink booster frequency can be different from the frequencies used by the cellular communication networks. In one example, the uplink booster frequency can include frequencies that are unused by the mobile device when transmitting the uplink signal to the first booster device 410. In this example, the uplink booster frequency can be a frequency in a white noise band, such as the frequency between 2300 MHz and 2400 MHz. In addition, the first uplink mixer circuit 422 can perform straight frequency mixing without adjusting the modulation scheme of the uplink signal.

In one example, the booster frequency for the first booster device 410 and the second booster device 480 can be selected based on interference concerns. In other words, the booster frequency can be selected to achieve interference mitigation.

Alternately or additionally, the first uplink mixer circuit 422 can convert the uplink signal to a different frequency and adjust the modulation scheme of the uplink signal. In this example, the first uplink mixer circuit 422 can demodulate the uplink signal, convert the frequency of the uplink signal to the uplink booster frequency, and then modulate or encode the uplink signal based on another wireless communication scheme. The first uplink mixer circuit 422 can digitize the uplink signal. For example, the first uplink mixer circuit 422 can convert the uplink signal from a cellular wireless signal based on 3G, 4G, or LTE wireless standards to an 802.11 wireless standard (with certain modifications to address an excessive transmit delay associated with the 802.11 wireless standard).

The first uplink mixer circuit 422 can provide the uplink signal at the uplink booster frequency to the first uplink amplification circuit 424. The first uplink amplification circuit 424 can be configured to apply a gain to the uplink signal. In one example, the gain applied to the uplink signal can be greater than, less than, or equal to one. The first uplink amplification circuit 424 can include one or more low-noise amplifiers, power amplifiers, attenuators, and filters, among other circuit components. The amplified uplink signal at the uplink booster frequency can be provided from a second duplexer 413 to the second interface port 414.

In one example, a path loss can be measured between the first booster device 410 and the second booster device 480 in the booster system 302. For example, a pilot signal can be sent at different frequencies between the first booster device 410 and the second booster device 480 to determine a path loss for each band. The gain can be adjusted based on the path loss between the first booster device 410 and the second booster device 480 in the booster system 302. As a result, the path loss can be effectively reduced in the booster system 302.

The second interface port 414 can be coupled to a first booster antenna 426. The first booster antenna 426 can be configured to transmit uplink wireless signal to and receive downlink wireless signals from a second booster antenna 456 coupled to the second booster device 480. The signals transmitted by the first booster antenna 426 can be signals at the uplink booster frequency. The signals received by the first booster antenna 426 can be signals at a downlink booster frequency.

The second booster antenna 456 can be coupled to a third interface port 482 of the second booster device 480. The second booster device 480 can further include a fourth interface port 484. The second booster device 480 can further include a second uplink path 450 coupled between the third interface port 482 and the fourth interface port 484. The second booster device 480 can also include a second downlink path 460 coupled between the third interface port 482 and the fourth interface port 484.

The second uplink path 450 can include a second uplink mixer circuit 452 and a second uplink amplification circuit 454. The second uplink mixer circuit 452 can be configured to receive the uplink signal from the second booster antenna 456 via the third interface port and a third duplexer 481, and to convert the uplink signal from the uplink booster frequency to the uplink cellular frequency. The uplink cellular frequency can be the frequency of the uplink signal when received by the first cellular antenna 402. When the first uplink mixer circuit 422 adjusts the modulation scheme of the uplink signal, the second uplink mixer circuit 452 can restore the modulation scheme of the uplink signal, such that the uplink signal has the same modulation as when the uplink signal was received by the first cellular antenna 402.

In one example, the second uplink mixer circuit 452 can convert the uplink signal from the uplink booster frequency to a second uplink cellular frequency that is different than the uplink cellular frequency of the uplink signal when received by the first cellular antenna 402. In this example, the second uplink cellular frequency can be an uplink cellular frequency that is used by the mobile device for wireless communication by wireless communication networks. In addition, the uplink cellular frequency and the second uplink cellular frequency can be frequencies in the same cellular frequency band or frequencies in the same channel of the same cellular frequency band.

The second uplink mixer circuit 452 can provide the uplink signal at the uplink cellular frequency to the second uplink amplification circuit 454. The second uplink amplification circuit 454 can be configured to apply a gain to the uplink signal. In one example, the gain applied to the uplink signal can be greater than, less than, or equal to one. The second uplink amplification circuit 454 can include one or more low-noise amplifiers, power amplifiers, attenuators, and filters, among other circuit components. The amplified uplink signal at the uplink cellular frequency can be provided from a fourth duplexer 483 to the fourth interface port 484.

The fourth interface port 484 can be coupled to a second cellular antenna 404. The second cellular antenna 404 can be configured to transmit uplink signals to and receive downlink signals from an access point, such as the access point 304 of FIG. 3. The frequencies of the uplink and downlink signals communicated between the second cellular antenna 404 and the access point can be frequencies associated with cellular communication networks and can be the same as the frequencies communicated between the first cellular antenna 402 and the wireless device.

The downlink signal received by the second cellular antenna 404 can be provided to the second downlink path 460. The second downlink path 460 can include a second downlink mixer circuit 462 and a second downlink amplification circuit 464. The second downlink mixer circuit 462 can be configured to receive the downlink signal at a downlink cellular frequency and to convert the downlink signal to a downlink booster frequency. The downlink booster frequency can be different from the frequencies used by the cellular communication networks. In one example, the downlink booster frequency can include frequencies that are unused by the access point when transmitting downlink signal to the second booster device 480. In addition, the downlink booster frequency uplink booster frequency can be a frequency in a white noise band, such as the frequency between 2300 MHz and 2400 MHz.

In one example, the downlink booster frequency can also be different than the uplink booster frequency. For example, a frequency gap can separate the downlink and uplink booster frequencies. The frequency gap can be sized such that the downlink and uplink booster frequencies can be adequately filtered direct the downlink and uplink booster frequencies into their appropriate paths in the first and second booster devices 410 and 480. In another example, the frequency gap can be 10, 20, 30, or 50 MHz.

In one example, the second downlink mixer circuit 462 can perform straight frequency mixing without adjusting the modulation scheme of the downlink signal. Thus, the data carried by the downlink signal may not be changed. Alternately or additionally, the second downlink mixer circuit 462 can convert the downlink signal to a different frequency and adjust the modulation scheme of the downlink signal. In this example, the second downlink mixer circuit 462 can demodulate the downlink signal, convert the frequency of the downlink signal to the downlink booster frequency, and then modulate or encode the downlink signal based on another wireless communication scheme. For example, the second downlink mixer circuit 462 can convert the downlink signal to from a cellular wireless signal based on 3G, 4G, or LTE wireless standards to an 802.11 wireless standard.

The second downlink mixer circuit 462 can provide the downlink signal at the downlink booster frequency to the second downlink amplification circuit 464. The second downlink amplification circuit 464 can be configured to apply a gain to the downlink signal. In one example, the gain applied to the downlink signal can be greater than, less than, or equal to one. The second downlink amplification circuit 464 can include one or more low-noise amplifiers, power amplifiers, attenuators, and filters, among other circuit components.

The downlink signal at the downlink booster frequency can be provided to the third interface port 482 by the second downlink amplification circuit 464. The third interface port 482 can provide the downlink signal to the second booster antenna 456. The second booster antenna 456 can transmit the downlink signal at the downlink booster frequency to the first booster antenna 426.

The first booster antenna 426 can receive the downlink signal at the downlink booster frequency and provide the downlink signal at the downlink booster frequency to the second interface port 414. The first booster device 410 can direct the downlink signal at the downlink booster frequency to the first downlink path 430.

The first downlink path 430 can include a first downlink mixer circuit 432 and a first downlink amplification circuit 434. The first downlink mixer circuit 432 can be configured to receive the downlink signal from the first booster antenna 426 and to convert the downlink signal from the downlink booster frequency to the downlink cellular frequency. The downlink cellular frequency can be the frequency of the downlink signal when received by the second cellular antenna 404. When the second downlink mixer circuit 462 adjusts the modulation scheme of the downlink signal, the first downlink mixer circuit 432 can restore the modulation scheme of the downlink signal such that the downlink signal has the same modulation as when the downlink signal was received at the second cellular antenna 404.

In one example, the first downlink mixer circuit 432 can convert the downlink signal from the downlink booster frequency to a second downlink cellular frequency that is different than the downlink cellular frequency of the downlink signal when received by the second cellular antenna 404. In this example, the second downlink cellular frequency can be a downlink cellular frequency that is used by the mobile device for wireless communication by wireless communication networks. In addition, the downlink cellular frequency and the second downlink cellular frequency can be frequencies in the same cellular frequency band or frequencies in the same channel of the same cellular frequency band.

The first downlink mixer circuit 432 can provide the downlink signal at the downlink cellular frequency to the second uplink amplification circuit 454. The second uplink amplification circuit 454 can be configured to apply a gain to the downlink signal. In one example, the gain applied to the downlink signal can be greater than, less than, or equal to one. The first downlink amplification circuit 434 can include one or more low-noise amplifiers, power amplifiers, attenuators, and filters, among other circuit components. The downlink signal at the downlink cellular frequency can be provided to the first interface port 412. The first interface port 412 can provide the downlink signal to the first cellular antenna 402 for transmission to the wireless device.

In one example, the first booster device 410 can include a first control unit 440 and the second booster device 480 can include a second control unit 470. The first control unit 440 may communicate with the second control unit 470. The first control unit 440 can be coupled to a first control antenna 442 and the second control unit 470 can be coupled to a second control antenna 472. In addition, the first control unit 440 and the second control unit 470 can communicate through wireless communications using the first control antenna 442 and the second control antenna 472.

The wireless communications between the first control unit 440 and the second control unit 470 can use a frequency different than the cellular frequencies used by the cellular wireless communication network and the frequencies used by the downlink booster frequencies and the uplink booster frequencies. In one example, the wireless communications between the first control unit 440 and the second control unit 470 can use a different modulation or communication standard than the cellular wireless communication network and the wireless communications between the first booster antenna 426 and the second booster antenna 456. In addition, the wireless communications between the first control unit 440 and the second control unit 470 can use any type of wireless communication standard, such as ZigBee®, Bluetooth®, WIFI®, near-field communication, among other wireless communication standards.

In one example, the first control unit 440 can control the gain applied to the uplink signal by the first uplink amplification circuit 424 and the gain applied to the downlink signal by the first downlink amplification circuit 434. The gain applied to the downlink signal by the first downlink amplification circuit 434 can be based on a signal level of the uplink signal as received by the first cellular antenna 402. Furthermore, the gain applied to the downlink signal by the first downlink amplification circuit 434 can also be based on a signal level of the downlink signal as received by the second cellular antenna 404 and/or the signal level of the downlink signal in the first downlink path 430 before the first downlink amplification circuit 434. The second control unit 470 can provide the signal levels of the downlink signal to the first control unit 440. The second control unit 470 providing signal level information to the first control unit 440 can help the system 400 to maintain a system gain below a particular gain threshold between the first interface port 412 and the fourth interface port 484.

In one example, the second control unit 470 can control the gain applied to the uplink signal by the second uplink amplification circuit 454 and the gain applied to the downlink signal by the second downlink amplification circuit 464. The gain applied to the uplink signal by the second uplink amplification circuit 454 can be based on a signal level of the downlink signal as received by the second cellular antenna 404. Furthermore, the gain applied to the uplink signal by the second uplink amplification circuit 454 can also be based on a signal level of the uplink signal as received by the first cellular antenna 402 and/or the signal level of the uplink signal in the second uplink path 450 before the second uplink amplification circuit 454. The first control unit 440 can provide the signal levels of the uplink signal to the second control unit 470. The first control unit 440 providing the signal level information to the second control unit 470 can help the system 400 to maintain a system gain below the particular threshold between the first interface port 412 and the fourth interface port 484.

In one configuration, a single control unit (or a main controller unit) can be included in either the first booster device 410 or the second booster device 480. The control unit can control the gain applied to the uplink signal by the first uplink amplification circuit 424 and the gain applied to the downlink signal by the first downlink amplification circuit 434. In addition, the control unit can control the gain applied to the uplink signal by the second uplink amplification circuit 454 and the gain applied to the downlink signal by the second downlink amplification circuit 464.

In one example, the gain applied to the downlink signal by the first downlink amplification circuit 434 and the gain applied to the uplink signal by the second uplink amplification circuit 454 can be determined based on conditions associated with communicating the wireless signals (e.g., providing noise floor protection in a wireless communication system that includes the system 400, internal oscillation of the system 400, external oscillation (e.g., antenna to antenna oscillations) of the system 400, and/or overload protection at an access point communicating with system 400).

In one example, the gain applied by the first uplink amplification circuit 424 and/or the frequency selected for mixing by the first uplink mixer circuit 422 can be controlled by the first control unit 440 based on a distance between the first booster antenna 426 and the second booster antenna 456 and a power level of the uplink signal in the first uplink path 420. Alternately or additionally, the gain applied by the second downlink amplification circuit 464 and/or the frequency selected for mixing by the second downlink mixer circuit 462 can be controlled by the second control unit 470 based on the distance between the first booster antenna 426 and the second booster antenna 456 and a power level of the downlink signal in the second downlink path 460.

The first control unit 440 can also be configured to control the first uplink mixer circuit 422 and the first downlink mixer circuit 432. The first control unit 440 can control the modulation schemes and/or the frequency of the uplink booster frequency applied to the uplink signal by the first uplink mixer circuit 422. The first control unit 440 can control the demodulation schemes and/or the frequency of the downlink cellular frequency applied to the downlink signal by the first downlink amplification circuit 434.

The second control unit 470 can also be configured to control the second uplink mixer circuit 452 and the second downlink mixer circuit 462. The second control unit 470 can control the modulation schemes and/or the frequency of the downlink booster frequency applied to the downlink signal by the second downlink mixer circuit 462. The second control unit 470 can control the demodulation schemes and/or the frequency of the uplink cellular frequency applied to the uplink signal by the second uplink mixer circuit 452.

In one example, each of the first control unit 440 and the second control unit 470 can be implemented by any suitable mechanism, such as a program, software, function, library, software as a service, analog, or digital circuitry, or any combination thereof. For example, each of the first control unit 440 and the second control unit 470 can include a processor and memory. The processor can include, for example, a microprocessor, microcontroller, digital signal processor (DSP), application-specific integrated circuit (ASIC), a Field-Programmable Gate Array (FPGA), or any other digital or analog circuitry configured to interpret and/or to execute program instructions and/or to process data. In addition, the processor can interpret and/or execute program instructions and/or process data stored in the memory.

Modifications, additions, or omissions can be made to the system 400 without departing from the scope of the present disclosure. For example, in one example, the first uplink path 420 can include additional circuit components such as filters, RF power detectors, and additional amplifiers before, after, or in-between the first uplink mixer circuit 422 and the first uplink amplification circuit 424. The first downlink path 430, the second uplink path 450, and the second downlink path 460 can include similar configurations. Alternately or additionally, each of the first uplink path 420, the first downlink path 430, the second uplink path 450, and the second downlink path 460 can include different configurations.

In one example, the first booster antenna 426 and the first control antenna 442 can be the same antenna. Alternately or additionally, the second booster antenna 456 and the second control antenna 472 can be the same antenna.

In one example, the system 400 can include additional interface ports that are coupled to antennas that are configured to communicate with wireless devices. Alternately or additionally, the system 400 can include multiple downlink and uplink amplification paths that are each configured to carry signals of different frequency bands of a wireless communication network. In addition, each of the downlink and uplink amplification paths can use booster frequencies at different frequencies.

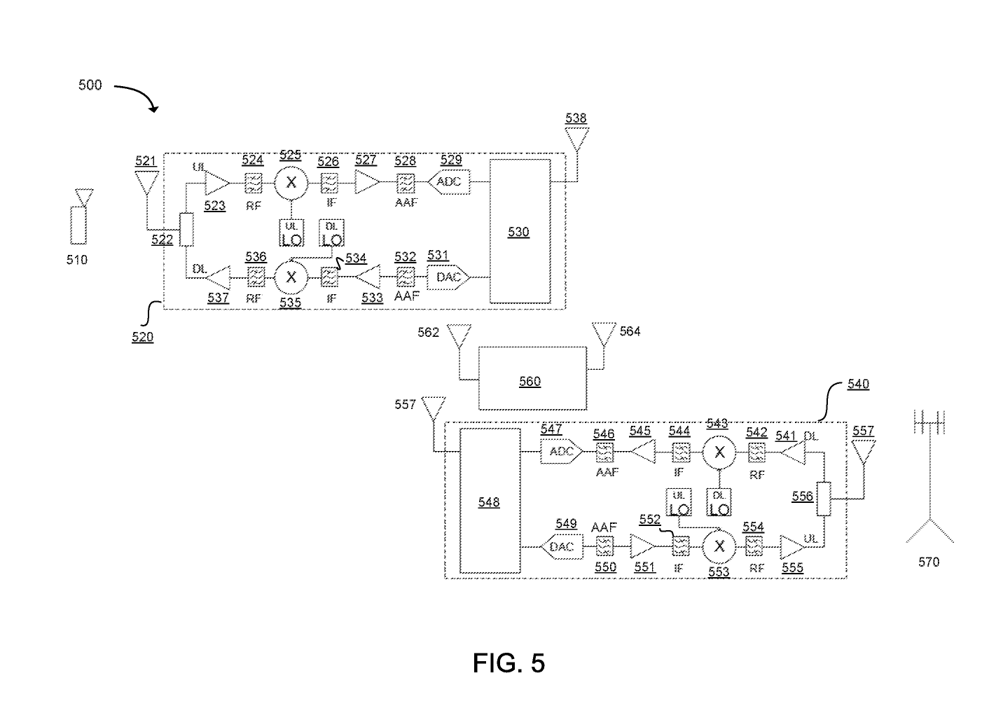

FIG. 5 illustrates an example of a wireless communication system 500. The wireless communication system 500 can include a user equipment (UE) 510, a first booster device 520, a second booster device 540, a repeater 560 and an eNodeB 570. The first booster device 520, the second booster device 540 and the repeater 560 can be included in a divided signal booster system. The divided signal booster system can be utilized for broadband signals. In one example, the first booster device 520 can be referred to as an indoor unit, and the second booster device 540 can be referred to as an outdoor unit. In another example, an outdoor unit can communicate with multiple indoor units. In addition, the repeater 560 can be a digital repeater that amplifies signals transmitted between the first booster device 520 and the second booster device 540.

In one configuration, the UE 510 can transmit a signal (e.g., an uplink signal) to the first booster device 520. The signal can be detected via a first antenna 521, and the signal can be provided to a first diplexer 522. The first diplexer 522 can direct the signal along an uplink signal path. For example, the signal can be provided to a first uplink amplifier 523, and then the signal can be provided to a first uplink radio frequency (RF) filter 524. The signal can be provided to a first uplink mixer and local oscillator (LO) 525, which can function to change a frequency of the signal. In one example, the frequency can be converted to a frequency in an ISM band (or unlicensed band). In another example, the frequency can be converted to a non-cellular transmit frequency. Then, the signal can be provided to a first uplink intermediate frequency (IF) filter 526, a second uplink amplifier 527, and a first uplink anti-aliasing filter (AAF) 528. The first uplink AAF 528 can be used before a signal sampler to restrict a bandwidth of the signal to satisfy a sampling theorem over a band of interest. The signal can be provided to an uplink analog to digital converter (ADC) 529 to convert the signal from analog to digital. Then, the signal can be provided to a first ISM chipset 530, and then to a second antenna 538 of the first booster device 520.

Furthermore, the signal can be transmitted from the second antenna 538 of the first booster device 520, and the signal can be detected at a third antenna 557 of the second booster device 540. The signal can be provided from the third antenna 557 to a second ISM chipset 548. Then, the signal can be provided to an uplink digital to analog converter (DAC) 549 to convert the signal from digital to analog, a second uplink AAF 550, a third uplink amplifier 551, a second uplink IF filter 552, a second uplink mixer and LO 553, a second uplink RF filter 554 and a fourth uplink amplifier 555. The signal can be provided to a second diplexer 556, and then the signal can be provided to a fourth antenna 557 for transmission to the eNodeB 570.

In one configuration, the repeater 560 can amplify signals transmitted from the first booster device 520 and the second booster device 540, or vice versa. For example, the repeater 560 can receive the signal at a first repeater antenna 562 (i.e., the signal transmitted from the second antenna 538 of the first booster device 520). The repeater 560 can amplify the signal, and then the signal can be transmitted from a second repeater antenna 564. The amplified signal can be detected at the third antenna 557 of the second booster device 540. Therefore, the repeater 560 can function to increase a range between the first booster device 520 and the second booster device 540.

In one configuration, the eNodeB 570 can transmit a signal (e.g., a downlink signal) to the second booster device 540. The signal can be detected via the fourth antenna 557, and the signal can be provided to the second diplexer 556. The second diplexer 556 can direct the signal along a downlink signal path. For example, the signal can be provided to a first downlink amplifier 541, and then the signal can be provided to a first downlink RF filter 542. The signal can be provided to a first downlink mixer and LO 543. Then, the signal can be provided to a first downlink IF filter 544, a second downlink amplifier 545, a first downlink AAF 546, and a downlink ADC 547. The signal can be provided to the second ISM chipset 548, and then to the third antenna 557 of the second booster device 540.

Furthermore, the signal can be transmitted from the third antenna 557 of the second booster device 540, and the signal can be detected at the second antenna 538 of the first booster device 520. The signal can be provided from the second antenna 538 to the first ISM chipset 530. Then, the signal can be provided to a downlink DAC 531, a second downlink AAF 532, a third downlink amplifier 533, a second downlink IF filter 534, a second downlink mixer and LO 535, a second downlink RF filter 536 and a fourth downlink amplifier 537. The signal can be provided to the first diplexer 522, and then the signal can be provided to the first antenna 521 for transmission to the UE 510.

In one example, the first uplink RF filter 524, the first uplink mixer and LO 525 and the first uplink IF filter 526 can be part of a first down conversion portion of the wireless communication system 500. The second uplink IF filter 552, the second uplink mixer and LO 553, and the second uplink RF filter 554 can be part of a second down conversion portion of the wireless communication system 500. The first and second down conversion portions of the wireless communication system 500 can be operable to down convert an entire uplink band. The down conversion can function to narrow a bandwidth. In another example, the first downlink RF filter 542, the first downlink mixer and LO 543 and the first downlink IF filter 544 can be part of a first up conversion portion of the wireless communication system 500. The second downlink RF filter 536, the second downlink mixer and LO 535 and the second downlink IF filter 534 can be part of a second up conversion portion of the wireless communication system 500. The first and second up conversion portions of the wireless communication system 500 can be operable to up convert an entire downlink band.

In one example, the LOs in the first booster device 520 can be synced with the LOs in the second booster device 540. For example, the first uplink mixer and LO 525 and the first downlink mixer and LO 543 in the first booster device 520 can be synced with the second uplink mixer and LO 553 and the second downlink mixer and LO 535 in the second booster device 540.

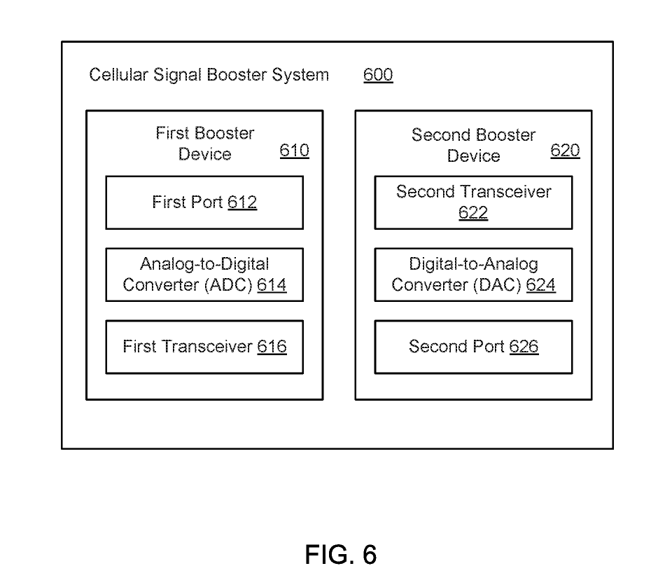

FIG. 6 illustrates an exemplary cellular signal booster system 600. The cellular signal booster system 600 can include a first booster device 610 and a second booster device 620. The first booster device 610 can include a first port 612, an analog to digital converter (ADC) 614, and a first transceiver 616. The first port 612 can be configured to receive a first analog cellular signal that carries information. The ADC 614 can be configured to convert the first analog cellular signal to a digital cellular signal without demodulating the first analog cellular signal. The first transceiver 616 can be configured to transmit the digital cellular signal over an unlicensed band. The second booster device 620 can include a second transceiver 622, a digital to analog converter (DAC) 624, and a second port 626. The second transceiver 622 can be configured to receive the digital cellular signal from the first booster device. The DAC 624 can be configured to convert the digital cellular signal to a second analog cellular signal, wherein the second analog cellular signal carries the information of the first analog cellular signal. The second port 626 can be configured to provide the second analog cellular signal for transmission.

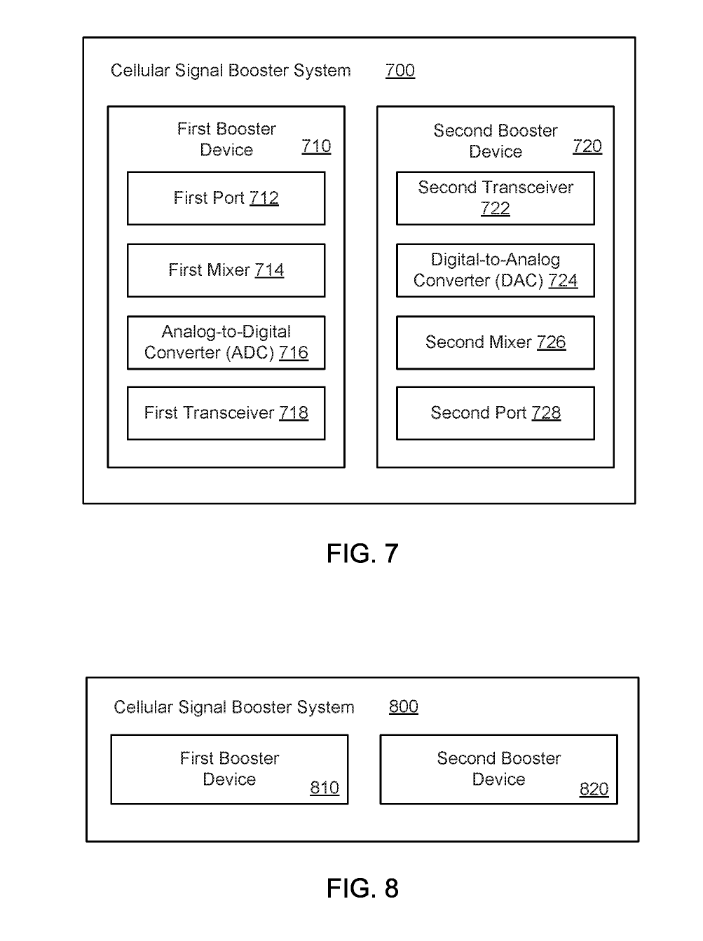

FIG. 7 illustrates an exemplary cellular signal booster system 700. The cellular signal booster system 700 can include a first booster device 710 and a second booster device 720. The first booster device 710 can include a first port 712, a first mixer 714, an analog to digital converter (ADC) 716, and a first transceiver 718. The first port 712 can be configured to receive a first analog cellular signal at a first frequency, and the first analog cellular signal carries information. The first mixer 714 can be configured to convert the first analog cellular signal at the first frequency to a second analog cellular signal at a second frequency. The ADC 716 can be configured to convert the second analog cellular signal at the second frequency to a digital cellular signal at the second frequency without demodulating the second analog cellular signal. The first transceiver 718 can be configured to transmit the digital cellular signal at the second frequency over an unlicensed band. The second booster device 720 can include a second transceiver 722, a digital to analog converter (DAC) 724, a second mixer 726, and a second port 728. The second transceiver 722 can be configured to receive the digital cellular signal at the second frequency from the first booster device. The DAC 724 can be configured to convert the digital cellular signal at the second frequency to a third analog cellular signal at the second frequency. The second mixer 726 can be configured to convert the third analog cellular signal at the second frequency to a fourth analog cellular signal at the first frequency, wherein the fourth analog cellular signal carries the information of the first analog cellular signal. The second port 728 can be configured to provide the fourth analog cellular signal at the first frequency for transmission.

FIG. 8 illustrates an exemplary cellular signal booster system 800. The cellular signal booster system 800 can include a first booster device 810 and a second booster device 820. The first booster device 810 can be operable to convert a cellular signal at a first frequency to a cellular signal at a second frequency. The second booster device 820 can be operable to receive the cellular signal at the second frequency over an unlicensed band from the first booster device, and convert the cellular signal at the second frequency to a cellular signal at the first frequency for transmission in a wireless communication network.

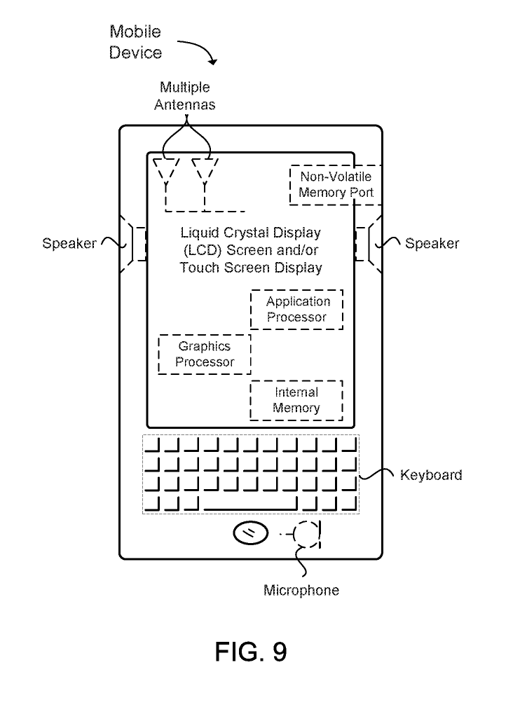

FIG. 9 provides an example illustration of the wireless device, such as a user equipment (UE), a mobile station (MS), a mobile communication device, a tablet, a handset, a wireless transceiver coupled to a processor, or other type of wireless device. The wireless device can include one or more antennas configured to communicate with a node or transmission station, such as an access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

FIG. 9 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be with the wireless device or wirelessly connected to the wireless device to provide additional user input. A virtual keyboard can also be provided using the touch screen.

### Examples

The following examples pertain to specific technology embodiments and point out specific features, elements, or actions that can be used or otherwise combined in achieving such embodiments.

Example 1 includes a cellular signal booster system, comprising: a first booster device, comprising: a first port configured to receive a first analog cellular signal that carries information; an analog to digital converter (ADC) configured to convert the first analog cellular signal to a digital cellular signal without demodulating the first analog cellular signal; and a first transceiver configured to transmit the digital cellular signal over an unlicensed band; and a second booster device, comprising: a second transceiver configured to receive the digital cellular signal from the first booster device; a digital to analog converter (DAC) configured to convert the digital cellular signal to a second analog cellular signal, wherein the second analog cellular signal carries the information of the first analog cellular signal; and a second port configured to provide the second analog cellular signal for transmission.

Example 2 includes the cellular signal booster system of Example 1, wherein: the first booster device further comprises a first mixer to convert the first analog cellular signal from a first frequency to a second frequency; and the second booster device further comprises a second mixer to convert the second analog cellular signal from the second frequency to the first frequency.

Example 3 includes the cellular signal booster system of any of Examples 1 to 2, wherein the first frequency is a cellular frequency used for cellular communication in the wireless communication network.

Example 4 includes the cellular signal booster system of any of Examples 1 to 3, wherein the second frequency is a non-cellular frequency.

Example 5 includes the cellular signal booster system of any of Examples 1 to 4, wherein the non-cellular frequency is in a range between 2400 megahertz and 2480 megahertz (MHz).

Example 6 includes the cellular signal booster system of any of Examples 1 to 5, wherein the non-cellular frequency is included in a 60 gigahertz (GHz) band or an industrial, scientific, and medical band (ISM band).

Example 7 includes the cellular signal booster system of any of Examples 1 to 6, wherein the ISM band includes a 5 GHz ISM band.

Example 8 includes the cellular signal booster system of any of Examples 1 to 7, wherein the second frequency is unused by a user equipment (UE) and one or more access points in a wireless communication network.

Example 9 includes the cellular signal booster system of any of Examples 1 to 8, further comprising a repeater communicatively coupled to the first booster device and the second booster device wherein the repeater is configured to amplify cellular signals communicated between the first booster device and the second booster device.

Example 10 includes a cellular signal booster system, comprising: a first booster device, comprising: a first port configured to receive a first analog cellular signal at a first frequency, and the first analog cellular signal carries information; a first mixer configured to convert the first analog cellular signal at the first frequency to a second analog cellular signal at a second frequency; an analog to digital converter (ADC) configured to convert the second analog cellular signal at the second frequency to a digital cellular signal at the second frequency without demodulating the second analog cellular signal; and a first transceiver configured to transmit the digital cellular signal at the second frequency over an unlicensed band; and a second booster device, comprising: a second transceiver configured to receive the digital cellular signal at the second frequency from the first booster device; a digital to analog converter (DAC) configured to convert the digital cellular signal at the second frequency to a third analog cellular signal at the second frequency; a second mixer configured to convert the third analog cellular signal at the second frequency to a fourth analog cellular signal at the first frequency, wherein the fourth analog cellular signal carries the information of the first analog cellular signal; and a second port configured to provide the fourth analog cellular signal at the first frequency for transmission.

Example 11 includes the cellular signal booster system of Example 10, wherein: the first frequency is a cellular frequency used for cellular communication in a wireless communication network; and the second frequency is a non-cellular frequency.

Example 12 includes the cellular signal booster system of any of Examples 10 to 11, wherein: the non-cellular frequency is in a range between 2400 megahertz and 2480 megahertz (MHz); or the non-cellular frequency is included in a 60 gigahertz (GHz) band or an industrial, scientific, and medical band (ISM band).

Example 13 includes the cellular signal booster system of any of Examples 10 to 12, wherein the ISM band includes a 5 GHz ISM band.

Example 14 includes the cellular signal booster system of any of Examples 10 to 13, wherein the second frequency is unused by a user equipment (UE) and one or more access points in a wireless communication network.

Example 15 includes the cellular signal booster system of any of Examples 10 to 14, further comprising a repeater communicatively coupled to the first booster device and the second booster device, wherein the repeater is configured to amplify cellular signals communicated between the first booster device and the second booster device.

Example 16 includes the cellular signal booster system of any of Examples 10 to 15, wherein the cellular signal is an uplink cellular signal or a downlink cellular signal.

Example 17 includes the cellular signal booster system of any of Examples 10 to 16, wherein: the first booster device further comprises a first cellular antenna configured to communicate cellular signals to a user equipment (UE); and the second booster device further comprises a second cellular antenna configured to communicate cellular signals to one or more access points in a wireless communication network

Example 18 includes the cellular signal booster system of any of Examples 10 to 17, wherein: the first booster device further comprises: a first control antenna; and a first control unit communicatively coupled to the first control antenna, the first control unit configured to control a first gain applied to analog cellular signals in the first booster device; and the second booster device further comprises: a second control antenna; and a second control unit communicatively coupled to the second control antenna, the second control unit configured to control a second gain applied to analog cellular signals in the second booster device.

Example 19 includes the cellular signal booster system of any of Examples 10 to 18, wherein the first booster device or the second booster device includes a control unit, wherein the control unit is configured to control a gain applied to analog cellular signals in the first booster device and the second booster device.

Example 20 includes the cellular signal booster system of any of Examples 10 to 19, wherein the first booster device is at a selected distance from the second booster device.

Example 21 includes the cellular signal booster system of any of Examples 10 to 20, wherein: the first booster device further comprises one or more amplifiers to amplify analog cellular signals; and the second booster device further comprises one or more amplifiers to amplify analog cellular signals.

Example 22 includes a cellular signal booster system, comprising: a first booster device operable to convert a cellular signal at a first frequency to a cellular signal at a second frequency; and a second booster device operable to receive the cellular signal at the second frequency over an unlicensed band from the first booster device, and convert the cellular signal at the second frequency to a cellular signal at the first frequency for transmission in a wireless communication network.

Example 23 includes the cellular signal booster system of Example 22, wherein the first booster device further comprises: a first port configured to receive the cellular signal at the first frequency; a first mixer configured to convert the cellular signal at the first frequency to the cellular signal at the second frequency; and a second port configured to provide the cellular signal at the second frequency for transmission over an unlicensed band.

Example 24 includes the cellular signal booster system of any of Examples 22 to 23, wherein the second booster device further comprises: a third port configured to receive the cellular signal at the second frequency from the first booster device; a second mixer configured to convert the cellular signal at the second frequency to the cellular signal at the first frequency; and a fourth port configured to provide the cellular signal at the first frequency for transmission in a wireless communication network.

Example 25 includes the cellular signal booster system of any of Examples 22 to 24, further comprising a repeater communicatively coupled to the first booster device and the second booster device, wherein the repeater is configured to amplify the cellular signal at the second frequency communicated between the first booster device and the second booster device.

Example 26 includes the cellular signal booster system of any of Examples 22 to 25, wherein: the first frequency is a cellular frequency used for cellular communication in the wireless communication network; and the second frequency is a non-cellular frequency, wherein the non-cellular frequency is included in a 60 gigahertz (GHz) band or an industrial, scientific, and medical band (ISM band), and the ISM band includes a 5 GHz ISM band.

Example 27 includes the cellular signal booster system of any of Examples 22 to 26, wherein the cellular signal at the first frequency is an analog cellular signal and the cellular signal at the second frequency is a digital cellular signal.

Various techniques, or certain aspects or portions thereof, can take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a random-access memory (RAM), erasable programmable read only memory (EPROM), flash drive, optical drive, magnetic hard drive, solid state drive, or other medium for storing electronic data. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

As used herein, the term processor can include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module can be implemented as a hardware circuit comprising custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be incorporated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A cellular signal booster system, comprising:
a first booster device, comprising:
a first port configured to receive a first analog cellular signal that carries information;
an analog to digital converter (ADC) configured to convert the first analog cellular signal to a digital cellular signal without demodulating the first analog cellular signal; and
a first transceiver configured to transmit the digital cellular signal over an unlicensed band; and
a second booster device, comprising:
a second transceiver configured to receive the digital cellular signal from the first booster device;
a digital to analog converter (DAC) configured to convert the digital cellular signal to a second analog cellular signal, wherein the second analog cellular signal carries the information of the first analog cellular signal; and
a second port configured to provide the second analog cellular signal for transmission.

2. The cellular signal booster system of claim 1, wherein:
the first booster device further comprises a first mixer to convert the first analog cellular signal from a first frequency to a second frequency; and
the second booster device further comprises a second mixer to convert the second analog cellular signal from the second frequency to the first frequency.

3. The cellular signal booster system of claim 2, wherein the first frequency is a cellular frequency used for cellular communication a the wireless communication network.

4. The cellular signal booster system of claim 2, wherein the second frequency is a non-cellular frequency.

5. The cellular signal booster system of claim 4, wherein the non-cellular frequency is in a range between 2400 megahertz and 2480 megahertz (MHz).

6. The cellular signal booster system of claim 4, wherein the non-cellular frequency is included in a 60 gigahertz (GHz) band or an industrial, scientific, and medical band (ISM band).

7. The cellular signal booster system of claim 6, wherein the ISM band includes a 5 GHz ISM band.

8. The cellular signal booster system of claim 2, wherein the second frequency is unused by a user equipment (UE) and one or more access points in a wireless communication network.

9. The cellular signal booster system of claim 1, further comprising a repeater communicatively coupled to the first booster device and the second booster device wherein the repeater is configured to amplify cellular signals communicated between the first booster device and the second booster device.

10. A cellular signal booster system, comprising:
a first booster device, comprising:
a first port configured to receive a first analog cellular signal at a first frequency, and the first analog cellular signal carries information;
a first mixer configured to convert the first analog cellular signal at the first frequency to a second analog cellular signal at a second frequency;
an analog to digital converter (ADC) configured to convert the second analog cellular signal at the second frequency to a digital cellular signal at the second frequency without demodulating the second analog cellular signal; and
a first transceiver configured to transmit the digital cellular signal at the second frequency over an unlicensed band; and
a second booster device, comprising:
a second transceiver configured to receive the digital cellular signal at the second frequency from the first booster device;
a digital to analog converter (DAC) configured to convert the digital cellular signal at the second frequency to a third analog cellular signal at the second frequency;
a second mixer configured to convert the third analog cellular signal at the second frequency to a fourth analog cellular signal at the first frequency, wherein the fourth analog cellular signal carries the information of the first analog cellular signal; and
a second port configured to provide the fourth analog cellular signal at the first frequency for transmission.

11. The cellular signal booster system of claim 10, wherein:
the first frequency is a cellular frequency used for cellular communication in a wireless communication network; and
the second frequency is a non-cellular frequency.

12. The cellular signal booster system of claim 11, wherein:
the non-cellular frequency is in a range between 2400 megahertz and 2480 megahertz (MHz); or
the non-cellular frequency is included in a 60 gigahertz (GHz) band or an industrial, scientific, and medical band (ISM band).

13. The cellular signal booster system of claim 12, wherein the ISM band includes a 5 GHz ISM band.

14. The cellular signal booster system of claim 10, wherein the second frequency is unused by a user equipment (UE) and one or more access points in a wireless communication network.

15. The cellular signal booster system of claim 10, further comprising a repeater communicatively coupled to the first booster device and the second booster device, wherein the repeater is configured to amplify cellular signals communicated between the first booster device and the second booster device.

16. The cellular signal booster system of claim 10, wherein the cellular signal is an uplink cellular signal or a downlink cellular signal.

17. The cellular signal booster system of claim 10, wherein:
the first booster device further comprises a first cellular antenna configured to communicate cellular signals to a user equipment (UE); and
the second booster device further comprises a second cellular antenna configured to communicate cellular signals to one or more access points in a wireless communication network

18. The cellular signal booster system of claim 10, wherein:
the first booster device further comprises:
a first control antenna; and
a first control unit communicatively coupled to the first control antenna, the first control unit configured to control a first gain applied to analog cellular signals in the first booster device; and
the second booster device further comprises:
a second control antenna; and
a second control unit communicatively coupled to the second control antenna, the second control unit configured to control a second gain applied to analog cellular signals in the second booster device.

19. The cellular signal booster system of claim 10, wherein the first booster device or the second booster device includes a control unit, wherein the control unit is configured to control a gain applied to analog cellular signals in the first booster device and the second booster device.

20. The cellular signal booster system of claim 10, wherein the first booster device is at a selected distance from the second booster device.

21. The cellular signal booster system of claim 10, wherein:
the first booster device further comprises one or more amplifiers to amplify analog cellular signals; and
the second booster device further comprises one or more amplifiers to amplify analog cellular signals.

22. A cellular signal booster system, comprising:
a first booster device operable to convert a cellular signal at a first frequency to a cellular signal at a second frequency; and
a second booster device operable to receive the cellular signal at the second frequency over an unlicensed band from the first booster device, and convert the cellular signal at the second frequency to a cellular signal at the first frequency for transmission in a wireless communication network.

23. The cellular signal booster system of claim 22, wherein the first booster device further comprises:
a first port configured to receive the cellular signal at the first frequency;
a first mixer configured to convert the cellular signal at the first frequency to the cellular signal at the second frequency; and
a second port configured to provide the cellular signal at the second frequency for transmission over an unlicensed band.

24. The cellular signal booster system of claim 23, wherein the second booster device further comprises:
a third port configured to receive the cellular signal at the second frequency from the first booster device;
a second mixer configured to convert the cellular signal at the second frequency to the cellular signal at the first frequency; and
a fourth port configured to provide the cellular signal at the first frequency for transmission in a wireless communication network.

25. The cellular signal booster system of claim 22, further comprising a repeater communicatively coupled to the first booster device and the second booster device, wherein the repeater is configured to amplify the cellular signal at the second frequency communicated between the first booster device and the second booster device.

26. The cellular signal booster system of claim 22, wherein:
the first frequency is a cellular frequency used for cellular communication in the wireless communication network; and
the second frequency is a non-cellular frequency, wherein the non-cellular frequency is included in a 60 gigahertz (GHz) band or an industrial, scientific, and medical band (ISM band), and the ISM band includes a 5 GHz ISM band.

27. The cellular signal booster system of claim 22, wherein the cellular signal at the first frequency is an analog cellular signal and the cellular signal at the second frequency is a digital cellular signal.
